(19) United States
(12) Patent Application Publication
(10) Pub. No.: US 2006/0269786 A1
(43) Pub. Date: Nov. 30, 2006

(54) Wiring for display device and thin film transistor array panel including the same and method for manufacturing thereof

(75) Inventors: Won-Suk Shin, Yongin-si (KR); Yang-Ho Bae, Suwon-si (KR); Hong-Sick Park, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd

(21) Appl. No.: 11/437,506

(22) Filed: May 18, 2006

(30) Foreign Application Priority Data
May 27, 2005 (KR) 10-2005-0044802

(51) Int. Cl. B32B 19/00

(52) U.S. Cl. 428/690

(57) ABSTRACT

A method of manufacturing a thin film transistor array panel, comprising forming a first signal line on a substrate, forming a gate insulating layer and a semiconductor layer on the first signal line in sequence, forming a second signal line on the gate insulating layer and the semiconductor layer, and forming a pixel electrode connected to the second signal layer. At least one of the first signal line and the second line comprise a first conductive oxide layer, a conductive layer containing silver (Ag), and a second conductive oxide layer formed at a lower temperature than that of the first conductive oxide layer.

### RELATED APPLICATION

This application claims priority to Korean Patent Application No. 2005-0044802, filed on May 27, 2005, and all the benefits accruing therefrom under 35 U.S.C. §119, and the contents of which in its entirety are herein incorporated by reference.

### BACKGROUND OF THE INVENTION

1. Field of the Invention

The present invention relates to wiring for a display device, a thin film transistor (TFT) array panel including the same, and a manufacturing method thereof.

2. Description of the Related Art

Liquid crystal displays (LCDs) are one of the most widely used flat panel displays. An LCD includes a liquid crystal (LC) layer interposed between two panels provided with field-generating electrodes. The LCD displays images by applying voltages to the field-generating electrodes to generate an electric field. The electric field in the LC layer determines the orientation of the LC molecules which change the polarization of incident light. Pixel electrodes are formed on a thin film transistor array panel. Images are displayed by applying a different voltage to each pixel electrode. Thin film transistors (TFTs) are used as a switching element to transmit image signals from data lines to the pixel electrodes in response to the scanning signals applied to the gate lines. The TFT is also used as a switching element for controlling respective light emitting elements of active matrix organic light emitting display (AM-OLED).

The trend toward larger size LCD and AM-OLED display devices requires that the lengths of the gate lines and the data lines become longer resulting in these lines exhibiting higher resistance which causes problems with signal delay. To solve this problem, the gate lines and the data lines are required to be made of a material having low resistivity, the lowest of which is silver (Ag). Unfortunately, silver adheres poorly to glass substrates and to layers made of inorganic or organic materials and therefore must be clad with other conductive materials. This, however, makes for a poor etched profile.

### SUMMARY OF THE INVENTION

In order to take advantage of the low resistivity of Ag wiring and to improve its adhesiveness and etched profile, the present invention provides wiring for a display device which comprises a first conductive layer comprising a first polycrystalline conductive oxide, a second conductive layer comprising silver (Ag), and a third conductive layer comprising a second polycrystalline conductive oxide formed from an amorphous conductive oxide. The present invention further provides a thin film transistor array panel comprising a substrate, a first signal line and a second signal line formed on the substrate and intersecting each other, a thin film transistor connected to the first signal line and the second signal line, and a pixel electrode connected to the thin film transistor. At least one of the first signal line and the second signal line comprises a first conductive layer comprising a first polycrystalline conductive oxide, a second conductive layer comprising silver (Ag), and a third conductive layer comprising a second polycrystalline conductive oxide formed from an amorphous conductive oxide.

The present invention further provides a method for manufacturing a thin film transistor array panel that comprises forming a first signal line on a substrate, forming a gate insulating layer and a semiconductor layer on the first signal line in sequence, forming a second signal line on the gate insulating layer and the semiconductor layer, and forming a pixel electrode connected to the second signal line. At least one of the formation of the first signal line and the formation of the second line comprises forming a first conductive oxide layer, forming a conductive layer containing silver (Ag), and forming a second conductive oxide layer at a lower temperature than that when forming the first conductive oxide layer.

### BRIEF DESCRIPTION OF THE DRAWINGS

FIG. 1 is a layout view of a TFT array panel according to an embodiment of the present invention;

FIGS. 2 and 3 are sectional views of the TFT array panel shown in FIG. 1 taken along the line II-II and the line III-III;

FIGS. 4, 7, 10, and 13 are layout views for sequentially illustrating the intermediate steps of a method of manufacturing a TFT array panel according to an embodiment of the present invention;

FIGS. 5 and 6 are sectional views of the TFT array panel shown in FIG. 4 taken along the line V-V and the line VI-VI;

FIGS. 8 and 9 are sectional views of the TFT array panel shown in FIG. 7 taken along the line VIII-VIII and the line IX-IX;

FIGS. 11 and 12 are sectional views of the TFT array panel shown in FIG. 10 taken along the line XI-XI and the line XII-XII;

FIGS. 14 and 15 are sectional views of the TFT array panel shown in FIG. 13 taken along the line XIV-XIV and the line XV-XV;

FIG. 16A is a sectional photograph of wiring where polycrystalline ITO, silver (Ag), and polycrystalline ITO are sequentially deposited; and

FIG. 16B is a sectional photograph of wiring where polycrystalline ITO, silver (Ag), and amorphous ITO are sequentially deposited.

### DETAILED DESCRIPTION OF THE PREFERRED EMBODIMENTS

Preferred embodiments of the present invention will now be described more fully hereinafter with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the invention to those skilled in the art. In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

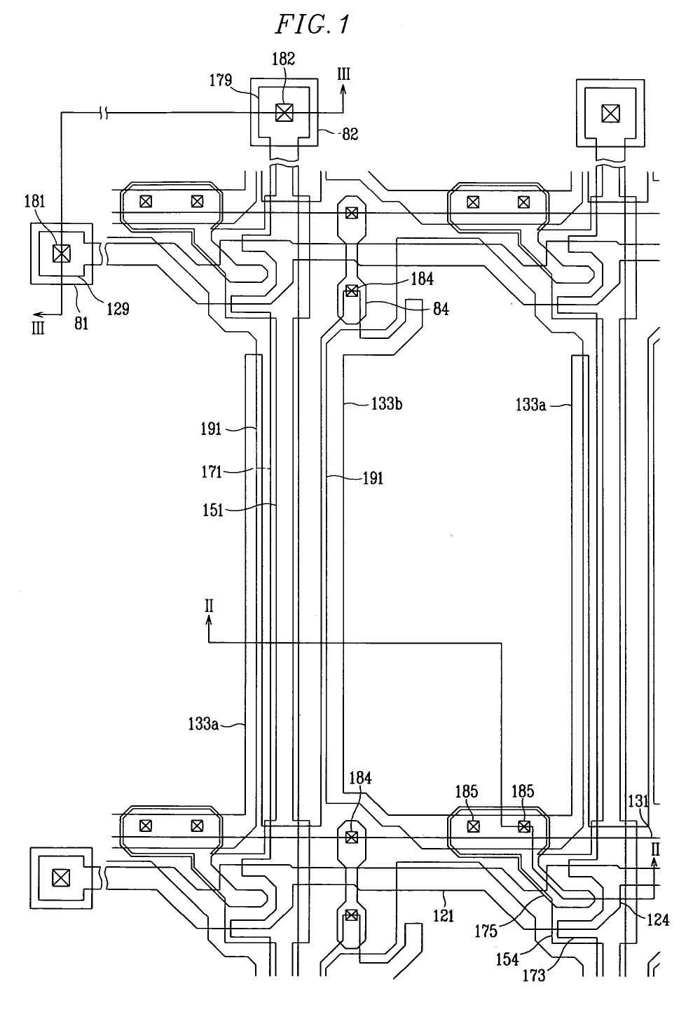

A TFT array panel according to an embodiment of the present invention will be described in detail with reference to FIGS. 1 to 3.

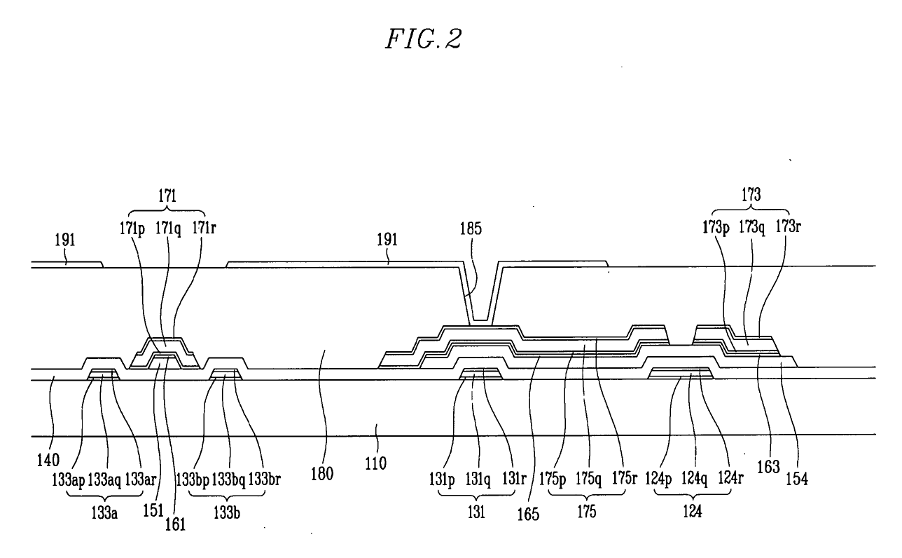

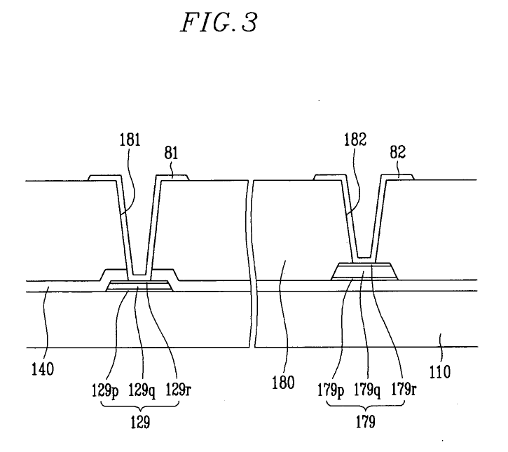

FIG. 1 is a layout view of a TFT array panel according to an embodiment of the present invention, and FIGS. 2 and 3 are sectional views of the TFT array panel shown in FIG. 1 taken along the line II-II and the line III-III, respectively.

A plurality of gate lines 121 and a plurality of storage electrode lines 131 are formed on an insulating substrate 110 made of a material such as transparent glass or plastic. Gate lines 121 transmit gate signals and extend in a substantially transverse direction. Each of the gate lines 121 includes a plurality of gate electrodes 124 that protrude downward and an end portion 129 having a large area for connection with another layer or an external driving circuit. A gate driver (not shown) for generating the gate signals may be mounted on a flexible printed circuit film (not shown) attached to the substrate 110. The gate driver may be directly fabricated on or integrate with substrate 110. When the gate driver is integrated into the substrate 110, the gate lines 121 may be extended to be directly connected to it.

The storage electrode line 131 for receiving the prescribed voltage includes a stem line running nearly parallel with the gate line 121 and a plurality of pairs of storage electrodes 133a and 133b. Each of the storage electrode lines 131 is located between two adjacent gate lines 121, and the stem line is near the lower one of the two gate lines 121. Each of the storage electrodes 133a and 133b includes a fixed terminal connected to the stem line and a free terminal on the opposite side. The fixed terminal of the storage electrode 133b has a large area, and the free terminal of the storage electrode 133b is divided into a straight portion and a crooked portion. However, the shape and disposition of the storage electrode line 131 may be variously changed.

The gate line 121 and the storage electrode line 131 have lower layers 133ap, 133bp, 131p, 124p and 129p made of a conductive oxide such as ITO (hereinafter, referred to as “lower ITO layers”), conductive layers 133aq, 133bq, 131q, 124q and 129q containing Ag (hereinafter, referred to as “Ag-containing layers”), and upper layers 133ar, 133br, 131r, 124r and 129r made of a conductive oxide such as ITO or IZO (hereinafter, referred to as “upper ITO layers”). The Ag-containing layers 133aq, 133bq, 131q, 124q and 129q have low resistivity to reduce the signal delay. The lower ITO layers 133ap, 133bp, 131p, 124p and 129p and the upper ITO layers 133ar, 133br, 131r, 124r and 129r enhance adhesiveness of the Ag-containing layers 133aq, 133bq, 131q, 124q and 129q to the substrate 110 or to the upper layer, respectively under and over the Ag-containing layers 133aq, 133bq, 131q, 124q and 129q. The Ag-containing layers 133aq, 133bq, 131q, 124q and 129q are thicker than the lower layers and upper ITO layers 133ap, 133bp, 131p, 124p and 129p and the upper layers 133ar, 133br, 131r, 124r and 129r.

The lower ITO layers 133ap, 133bp, 131p, 124p and 129p and the upper ITO layers 133ar, 133br, 131r, 124r and 129r are formed in a different temperature conditions from each other. The lower ITO layers 133ap, 133bp, 131p, 124p and 129p are formed into crystalline ITO at a temperature over about 150° C., and preferably about 200 to 350° C. On the other hand, the upper ITO layers 133ar, 133br, 131r, 124r and 129r are formed into amorphous ITO at a temperature between about 25 and 150° C., and preferably room temperature. By making the forming temperature of the lower ITO layers 133ap, 133bp, 131p, 124p and 129p and the upper ITO layers 133ar, 133br, 131r, 124r and 129r different from each other, the etched profiles of the lower ITO layers 133ap, 133bp, 131p, 124p and 129p, the Ag-containing layers 133aq, 133bq, 131q, 124q and 129q, and the upper ITO layers 133ar, 133br, 131r, 124r and 129r are improved.

Whether a conductive oxide such as ITO or IZO has a crystalline structure or not is determined according to its forming temperature, and the etching speed is also determined accordingly. In general, the etching speed of an amorphous structure is higher than for a polycrystalline structure. Therefore, while ITO layers are formed under and over the Ag-containing layers to improve adhesiveness, the profiles are formed to have a gentle inclination angle by forming the upper ITO layers with amorphous ITO which is etched rapidly and the lower ITO layers with polycrystalline ITO which is relatively etched slower.

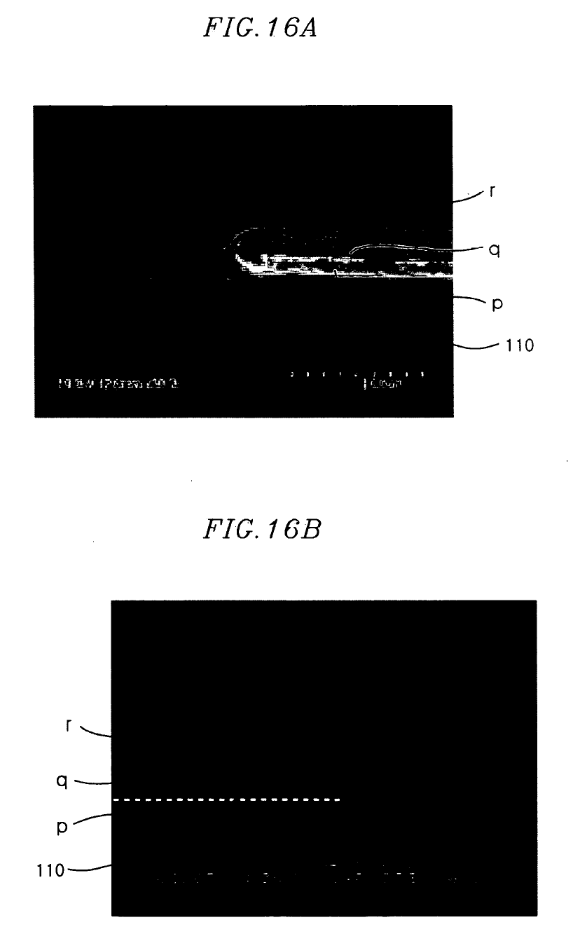

FIGS. 16A and 16B are sectional photographs of lower and upper ITO layers formed at the same and different temperatures, respectively. FIG. 16A shows that a round profile is formed when a lower ITO layer p and an upper ITO layer r are formed at a high temperature of about 300° C. under and over an Ag-containing layer q on the substrate 110. The round profile is formed since the etching speeds of the lower ITO layer p and the upper ITO layer r are the same.

On the contrary, FIG. 16B is a sectional photograph of ITO layers formed at different temperatures under and over an Ag containing layer q on the substrate 110, where the lower ITO layer p is formed at a high temperature of about 300° C. and the upper ITO layer r is formed at room temperature. Here, a good profile is formed due to the difference in etching speeds of the two layers p and r. The lateral sides of the gate lines 121 and the storage electrode lines 131 are inclined relative to a surface of the substrate 110, and the preferable inclination angle thereof ranges from about 30 to 80 degrees.

A gate insulating layer 140 made of a material such as silicon nitride (SiNx) or silicon oxide (SiOx) is formed on the gate lines 121, the storage electrode lines 131 and the substrate 110. A plurality of semiconductor stripes 151 made of a material such as hydrogenated amorphous silicon (abbreviated to “a-Si”) or polysilicon are formed on the gate insulating layer 140. Each semiconductor stripe 151 extends substantially in the longitudinal direction and has a plurality of projections 154 branched out toward the gate electrodes 124. The width of each semiconductor stripe 151 becomes large near the gate lines 121 and the storage electrode lines 131 to cover large areas of the gate lines 121 and the storage electrode lines 131. A plurality of ohmic contact stripes 161 and islands 165 are formed on the semiconductor stripes 151. The ohmic contacts 161 and 165 may be made of a material such as n+ hydrogenated a-Si heavily doped with an n-type impurity such as phosphorus (P) or silicide. Each ohmic contact stripe 161 has a plurality of projections 163, and the projections 163 and the ohmic contact islands 165 are located in pairs on the projections 154 of the semiconductor stripes 151. The lateral sides of the semiconductor stripes 151 and the ohmic contacts 161 and 165 are also inclined relative to a surface of the substrate 110, and the inclination angle thereof ranges from about 30 to 80 degrees.

A plurality of data lines 171 and a plurality of drain electrodes 175 are formed on the ohmic contacts 161 and 165 and the gate insulating layer 140. The data lines 171 for transmitting data voltages extend substantially in the longitudinal direction and intersect the gate lines 121. Each data line 171 also intersects the storage electrode lines 131 and is located between the adjacent storage electrodes 133a and 133b. Each data line 171 includes a plurality of source electrodes 173 branched out toward the gate electrodes 124 and an end portion 179 having a large area for connection with another layer or an external driving circuit. The data driver (not shown) for generating the data signals may be mounted on a flexible printed circuit film (not shown) attached to the substrate 110, directly fabricated on the substrate 110, or integrated into the substrate 110. When the data driver is integrated into the substrate 110, the data lines 121 may be extended to be directly connected to it.

Each drain electrode 175 is separated from the data line 171 and opposes the source electrode 173 with respect to a gate electrode 124. Each drain electrode 175 has an end portion having a large area and the end portion is stick-shaped. The end portion having a large area overlaps the storage electrode line 131, and the stick-shaped end portion is partially surrounded by the source electrode 173 curved in the shape of U.

A gate electrode 124, a source electrode 173, and a drain electrode 175, along with a projection 154 of a semiconductor stripe 151, form a TFT having a channel formed in the projection 154 disposed between the source electrode 173 and the drain electrode 175. The data line 171 and the drain electrode 175 have lower layers 171p, 173p, 175p, and 179p made of a conductive oxide such as ITO (hereinafter, referred to as “lower ITO layers”), conductive layers 171q, 173q, 175q, and 179q containing Ag (hereinafter, referred to as “Ag-containing layers”), and upper layers 171r, 173r, 175r, and 179r made of a conductive oxide such as ITO or IZO (hereinafter, referred to as “upper ITO layers”). The Ag-containing layers 171q, 173q, 175q, and 179q have low resistivity to reduce the signal delay. The lower ITO layers 171p, 173p, 175p, and 179p and the upper ITO layers 171r, 173r, 175r, and 179r enhance adhesiveness of the Ag-containing layers 171q, 173q, 175q, and 179q to a lower layer or an upper layer, respectively under and over the Ag-containing layers 171q, 173q, 175q, and 179q. The Ag-containing layers 171q, 173q, 175q, and 179q are thicker than the lower ITO layers 171p, 173p, 175p, and 179p and the upper layers 171r, 173r, 175r, and 179r.

Here, the lower ITO layers 171p, 173p, 175p, and 179p and the upper ITO layers 171r, 173r, 175r, and 179r are formed in different temperature conditions from each other. The lower ITO layers 171p, 173p, 175p, and 179p are formed into crystalline ITO at a temperature over about 150° C., and preferably between about 200 and 350° C. On the other hand, the upper ITO layers 171r, 173r, 175r, and 179r are formed into amorphous ITO at a temperature between about 25 and 150° C., and preferably at room temperature.

As mentioned above, by making the forming temperature of the lower ITO layers 171p, 173p, 175p, and 179p and the upper ITO layers 171r, 173r, 175r, and 179r different from each other, the etched profiles of the lower ITO layers 171p, 173p, 175p, and 179p, the Ag-containing layers 171q, 173q, 175q, and 179q, and the upper ITO layers 171r, 173r, 175r, and 179r are improved.

Whether a conductive oxide such as ITO or IZO has a crystalline structure or not is determined according to its forming temperature, and the etching speed is determined accordingly. In general, the etching speed of the amorphous structure is higher than that of the polycrystalline structure. Therefore, while ITO layers are formed under and over the Ag-containing layers to improve adhesiveness, the profiles are formed to have gentle inclination angles by forming the upper ITO layers with amorphous ITO which is etched rapidly and the lower ITO layers with polycrystalline ITO which is etched relatively slower.

The lateral sides of the data lines 171 and the drain electrode 175 are also inclined relative to a surface of the substrate 110, and the inclination angles thereof are preferably in a range of about 30 to 80 degrees.

The ohmic contacts 161 and 165 are interposed only between the underlying semiconductor stripes 151 and the overlying data lines 171 and drain electrodes 175 thereon, and reduce the contact resistance therebetween. Most of the semiconductor stripe 151 is narrower than the data line 171, but as mentioned above, the width of the semiconductor stripe 151 broadens near a place where the semiconductor stripe 151 and the gate line 121 meet each other to make the profile of the surface smooth and prevent disconnection of the data line 171. The semiconductor stripe 151 is partially exposed at the place between the source electrode 173 and the drain electrode 175 and at other places not covered with the data line 171 and the drain electrode 175.

A passivation layer 180 is formed on the data line 171, the drain electrode 175, and the exposed portion of the projection 154 of the semiconductor stripe 151. The passivation layer 180 is made of a material such as an inorganic insulator such as silicon nitride or silicon oxide, an organic insulator, or a low dielectric insulator. The organic insulator and the low dielectric insulator have dielectric constants that are preferably lower than 4.0, and examples of the low dielectric insulators are a-Si:C:O and a-Si:O:F formed by plasma enhanced chemical vapor deposition (PECVD). The passivation layer 180 may be made of an organic insulator having photosensitivity, and the surface thereof may be flat. However, the passivation layer 180 may have a double-layered structure including a lower inorganic layer and an upper organic layer so as to protect the exposed portion of the projections 154 of the semiconductor stripes 151 as well as to make use of the substantial insulating property of an organic layer.

The passivation layer 180 has a plurality of contact holes 182 and 185 exposing the end portions 179 of the data lines 171 and portions of the drain electrodes 175, respectively. The passivation layer 180 and the gate insulating layer 140 have a plurality of contact holes 181 exposing the end portions 129 of the gate lines 121 and a plurality of contact holes 184 exposing portions of the storage electrode lines 131 near the fixed terminals of the storage electrodes 133b.

A plurality of pixel electrodes 191, a plurality of overpasses 84, and a plurality of contact assistants 81 and 82, which may be made of a transparent conductor such as ITO or IZO or a reflective metal such as Al, Ag, or an alloy thereof, are formed on the passivation layer 180. The pixel electrode 191 is physically and electrically connected with the drain electrode 175 through the contact hole 185 and receives the data voltage from the drain electrode 175. The pixel electrode 191 to which the data voltage is applied generates an electric field with a common electrode (not shown) of the opposite panel (not shown) to which a common voltage is applied, so that the direction of the liquid crystal molecules in the liquid crystal layer (not shown) interposed between the two electrodes are determined. The pixel electrode 191 and the common electrode form a capacitor (hereinafter, referred to as a “liquid crystal capacitor”) to store and preserve the received voltage after the TFT is turned off.

The pixel electrode 191 overlaps the storage electrode line 131 including the storage electrodes 133a and 133b. To enhance the voltage storage ability, another capacitor is provided, which is connected with the liquid crystal capacitor in parallel and will be referred to as a “storage capacitor.” The pixel electrode 191 and the drain electrode 175 that are electrically connected with the pixel electrode 191 overlap the storage electrode line 131 to form a capacitor referred to as a storage capacitor, which enhances the voltage storage ability of the liquid crystal capacitor. The contact assistants 81 and 82 are respectively connected to the end portion 129 of the gate line 121 and the end portion 179 of the data line 171 through the contact holes 181 and 182. The contact assistants 81 and 82 respectively supplement adhesion between the end portion 129 of the gate line 121 and the exterior devices and between the end portion 179 of the data line 171 and the exterior devices, and protect them.

The overpass 84 traverses the gate line 121, and is connected to the exposed portion of the storage electrode line 131 and the exposed end portion of the free terminal of the storage electrode 133b through the contact holes 184 which are disposed opposite each other with the gate line 121 located therebetween. The storage electrode lines 131 including the storage electrodes 133a and 133b, along with the overpasses 84, may be used to repair defects of the gate lines 121, the data lines 171, or the TFTs.

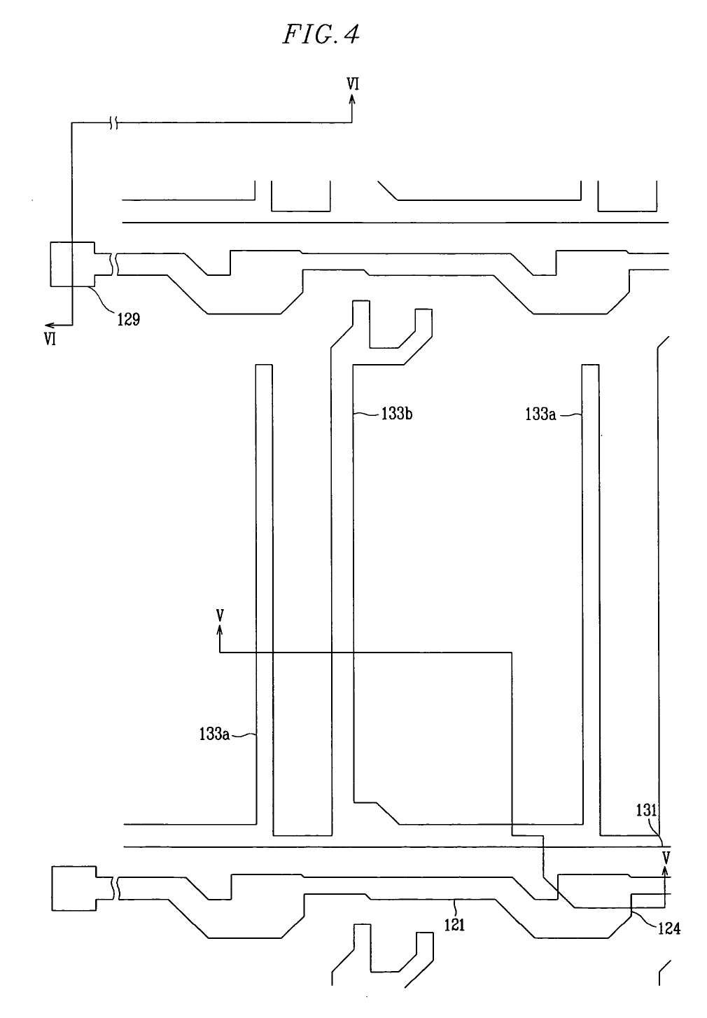

Now, a method of manufacturing the TFT array panel shown in FIGS. 1 to 3 will be described in detail with reference to FIGS. 4 to 15.

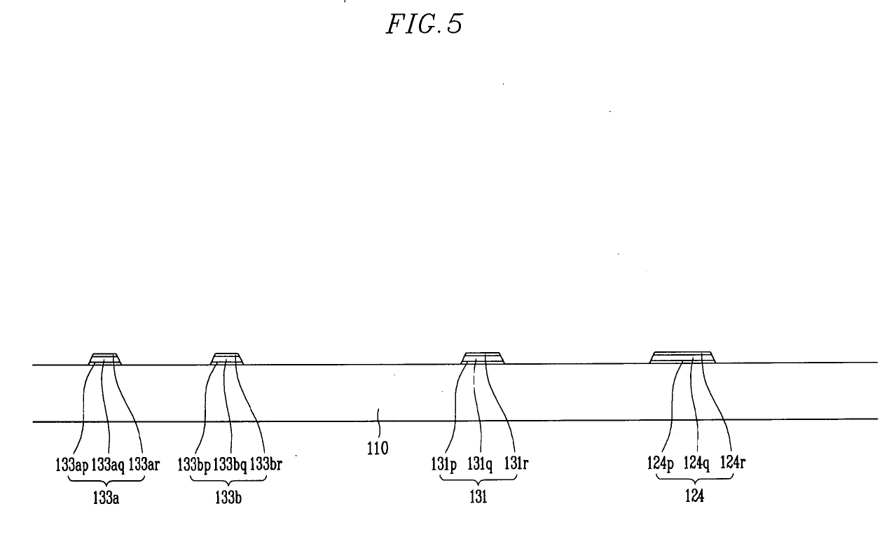

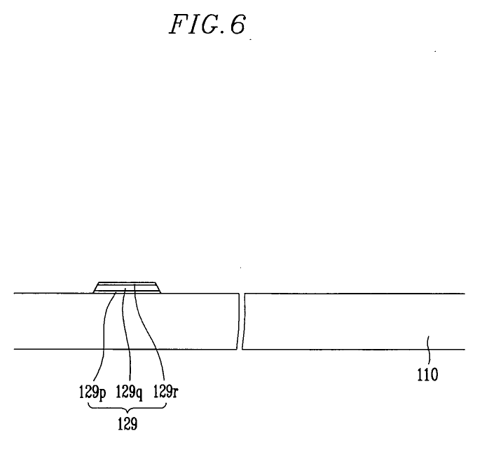

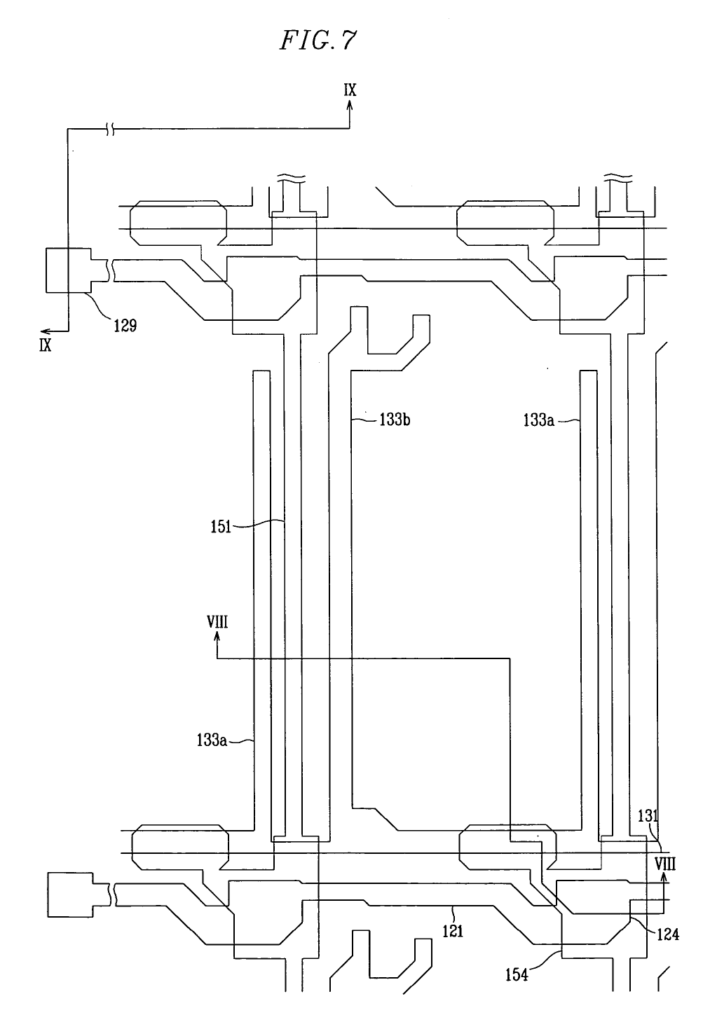

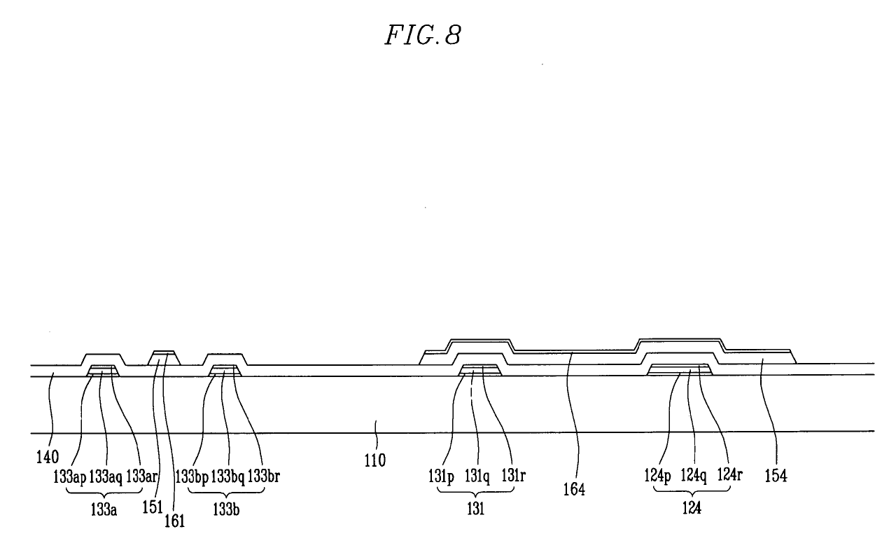

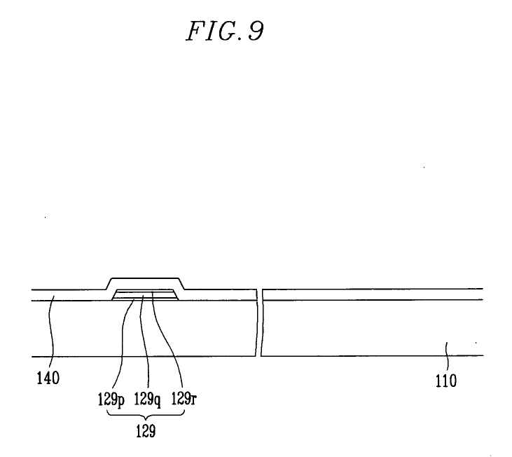

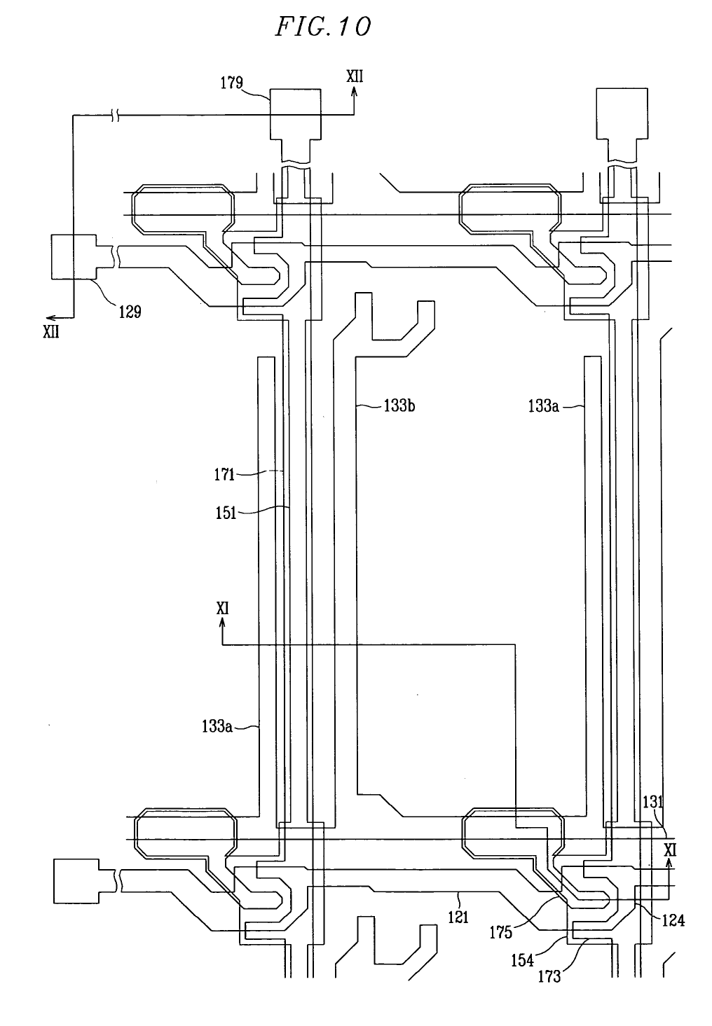

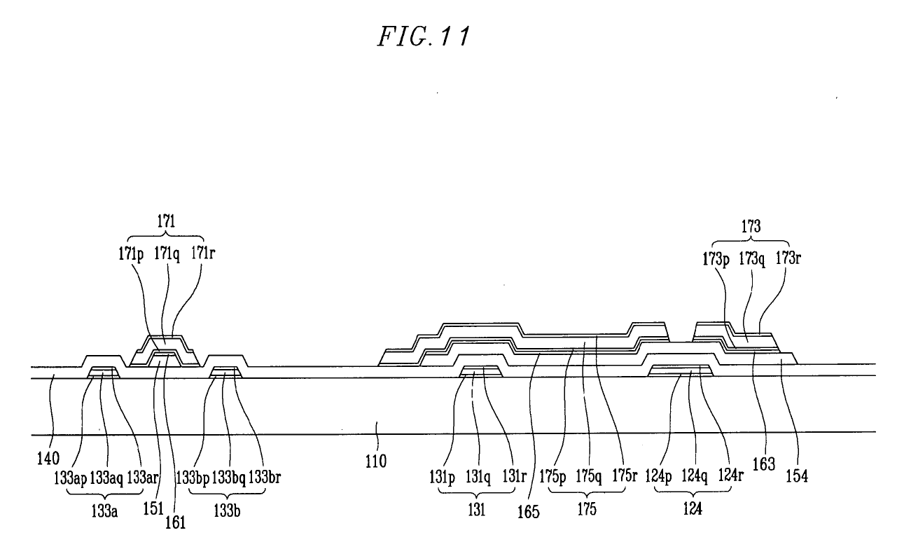

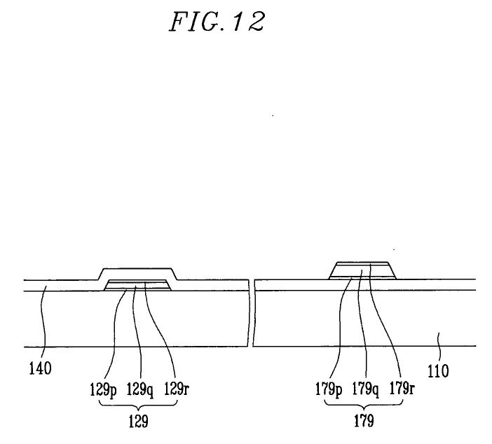

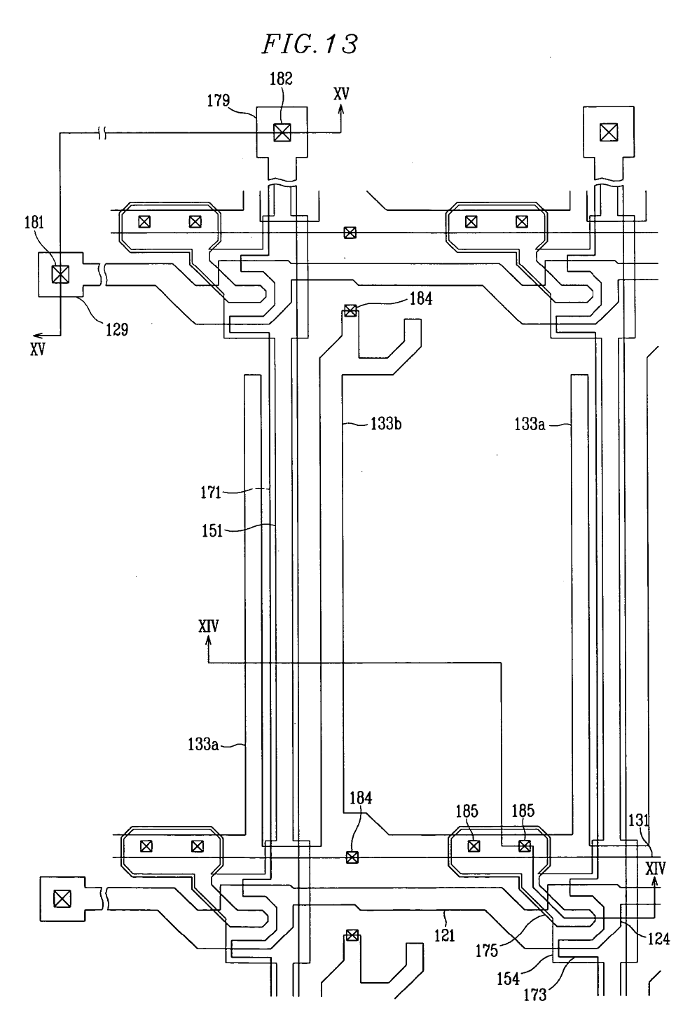

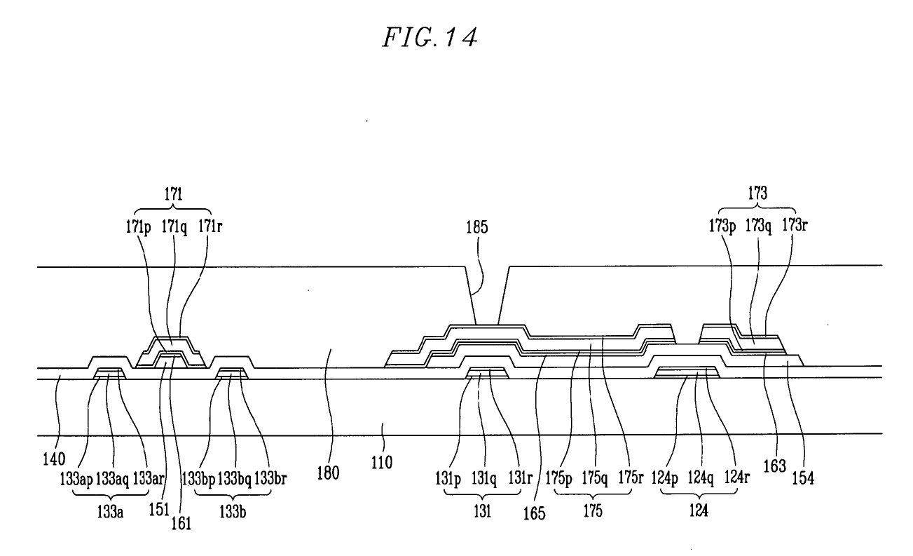

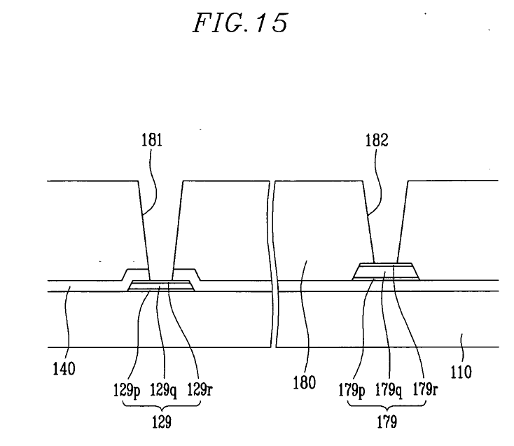

FIGS. 4, 7, 10, and 13 which are layout views for sequentially illustrating the intermediate steps of a method of manufacturing a TFT array panel according to an embodiment of the present invention. FIGS. 5 and 6 are sectional views of the TFT array panel shown in FIG. 4 taken along the line V-V and the line VI-VI, FIGS. 8 and 9 are sectional views of the TFT array panel shown in FIG. 7 taken along the line VIII-VIII and the line IX-IX, and FIGS. 11 and 12 are sectional views of the TFT array panel shown in FIG. 10 taken along the line XI-XI and the line XII-XII. FIGS. 14 and 15 are sectional views of the TFT array panel shown in FIG. 13 taken along the line XIV-XIV and the line XV-XV.

First, a lower ITO layer, an Ag-containing layer, and an upper ITO layer are sequentially deposited on an insulating substrate 110 made of a material such as transparent glass or plastic. Here, the ITO layer and the Ag-containing layer are formed by sputtering. First, power is applied to the ITO target while no power is applied to the Ag target to deposit an ITO layer on the substrate 110. Here, the temperature of the sputtering is over about 150° C., and preferably about 200 to350° C. When the sputtering is performed in such a range of temperature, a polycrystalline ITO layer is formed. After the power applied to the ITO target is turned off, power is applied to the Ag target to deposit an Ag-containing layer on the lower ITO layer.

After the power applied to the Ag target is turned off, power is applied again to the ITO target to deposit an ITO layer on the Ag-containing layer. Here, the temperature of the sputtering is between about 25 and 150° C., and is preferably room temperature. When the sputtering is performed at such temperature range, an amorphous ITO layer is formed. Moreover, hydrogen gas (H2) or water vapor (H2O) may be applied together during sputtering to increase its efficiency. Also, nitrogen gas (N2) may be applied together during sputtering to form ITO nitride. Here, an increase of resistance may be prevented by preventing diffusion of Ag into the ITO layer due to form nitride at the interface of the Ag-containing layer and the ITO layer.

Next, as shown in FIGS. 4 to 6, the lower ITO layer, the Ag layer, and the upper ITO layer are simultaneously wet etched to form gate lines 121 having gate electrodes 124 and end portions 129, and storage electrode lines 131 having storage electrodes 133a and 133b. Here, the etchant may be a hydrogen peroxide (H2O2) etchant or an etchant containing phosphoric acid (H2PO3), nitric acid (HNO3), acetic acid (CH3COOH), and deionized water for the remainder in an appropriate ratio thereof.

Next, SiNx, intrinsic a-Si, and a-Si doped with an impurity are sequentially deposited on the gate line 121, the storage electrode line 131 and the substrate 110. Here, since the deposition temperature is over about 250° C., every upper ITO layer included in the gate line 121 and the storage electrode line 131 is formed into polycrystalline ITO.

Then, the a-Si doped with an impurity and the intrinsic a-Si are etched to form a gate insulating layer 140, semiconductor stripes 151 including a plurality of projections 154 made of intrinsic a-Si, and ohmic contact stripes 161 including a plurality of ohmic contact patterns 164 made of a-Si doped with the impurity.

Next, a lower ITO layer, an Ag-containing layer, and an upper ITO layer are sequentially formed on the ohmic contact stripes 161 and the gate insulating layer 140. Here, the lower ITO layer, the Ag-containing layer and the upper ITO layer are formed by sputtering as with the gate line 121 and the storage electrode line 131. Next, as shown in FIGS. 10 to 12, the lower ITO layer, the Ag-containing layer, and the upper ITO layer are simultaneously wet etched to form data lines 171 having source electrodes 173 and end portions 179, and drain electrodes 175.

Next, exposed portions of the ohmic contact patterns 164 which are not covered with the source electrodes 173 and the drain electrodes 175 are removed to complete a plurality of ohmic contact stripes 161 having a plurality of projections 163 and a plurality of ohmic contact islands 165, and to expose the projections 154 of semiconductor stripes 151 below. Here, oxygen (O2) plasma treatment may follow thereafter in order to stabilize the exposed surfaces of the projections 154. Next, as shown in FIGS. 13 to 15, an organic material having substantial passivation properties and photosensitivity, an inorganic material such as SiNx, or a low dielectric insulating material is deposited to form a passivation layer 180 by plasma enhanced chemical vapor deposition (PECVD). Since the deposition is performed at a high temperature over about 250° C., the upper ITO layer included in the data line 171 and the drain electrode 175 is crystallized to become polycrystalline ITO.

The photoresist is then coated on the passivation layer 180 and exposed to a light through a photo-mask, and the exposed photoresist is thereby developed to form a plurality of contact holes 181, 182, 184, and 185. Next, as shown in FIGS. 1 to 3, a transparent conductive layer such as ITO is deposited on the passivation layer 180 by sputtering and then patterned to form pixel electrodes 191, contact assistants 81 and 82, and overpasses 84. In the present embodiment, both the gate line and the data line are formed to have a lower ITO layer, an Ag-containing layer, and an upper ITO layer, but this arrangement may be applied to only one thereof. As in the above descriptions, low resistivity, adhesiveness with upper and under layers, and profile are all improved by forming conductive oxide layers under and over the Ag-containing layers in different forming conditions.

Although preferred embodiments of the present invention have been described in detail hereinabove, it should be clearly understood that many variations and/or modifications of the basic inventive concepts herein taught, which may appear to those skilled in the present art, will still fall within the spirit and scope of the present invention, as defined in the appended claims.

What is claimed is:

1. Wiring for a display device, comprising:
a first conductive layer comprising a first polycrystalline conductive oxide;
a second conductive layer comprising silver (Ag); and
a third conductive layer comprising a second polycrystalline conductive oxide formed from an amorphous conductive oxide.

2. Wiring for a display device of claim 1, wherein the first polycrystalline conductive oxide is polycrystalline ITO.

3. Wiring for a display device of claim 1, wherein the amorphous conductive oxide is amorphous ITO or IZO.

4. Wiring for a display device of claim 1, wherein the third conductive layer is formed by crystallizing an amorphous conductive oxide.

5. Wiring for a display device, comprising:
a first conductive layer comprising a first conductive oxide;
a second conductive layer comprising Ag formed on the first conductive layer; and
a third conductive layer formed on the second layer, the third conductive layer comprising a second conductive oxide,
wherein the first conductive layer and the third conductive layer are formed at different temperatures from each other.

6. Wiring for a display device of claim 5, wherein the third conductive layer is formed at a lower temperature than the first conductive layer.

7. A thin film transistor array panel comprising:
a substrate;
a first signal line and a second signal line formed on the substrate, the first signal line and the second signal line intersecting each other;
a thin film transistor connected to the first signal line and the second signal line; and
a pixel electrode connected to the thin film transistor,
wherein at least one of the first signal line and the second signal line comprises a first conductive layer comprising a first polycrystalline conductive oxide, a second conductive layer comprising silver (Ag), and a third conductive layer comprising a second polycrystalline conductive oxide formed from an amorphous conductive oxide.

8. The thin film transistor array panel of claim 7, wherein the first polycrystalline conductive oxide is polycrystalline ITO.

9. The thin film transistor array panel of claim 7, wherein the third conductive layer is formed by crystallizing an amorphous conductive oxide.

10. The thin film transistor array panel of claim 7, wherein the first conductive layer and the third conductive layer are formed at different temperatures from each other.

11. The thin film transistor array panel of claim 10, wherein the third conductive layer is formed at a lower temperature than that of the first conductive layer.

12. The thin film transistor array panel of claim 7, wherein the second conductive layer is thicker than the first conductive layer and the third conductive layer.

13. A manufacturing method of a thin film transistor array panel, comprising:
forming a first signal line on a substrate;
forming a gate insulating layer and a semiconductor layer on the first signal line in sequence;
forming a second signal line on the gate insulating layer and the semiconductor layer; and
forming a pixel electrode connected to the second signal layer,
wherein at least one of the formation of the first signal line and the formation of the second line comprises forming a first conductive oxide layer, forming a conductive layer containing silver (Ag), and forming a second conductive oxide layer at a lower temperature than the first conductive oxide layer.

14. The method of claim 13, wherein the formation of the first conductive oxide layer is performed at a temperature of over 150° C.

15. The method of claim 13, wherein the formation of the second conductive oxide layer is performed at a temperature of 25 to 150° C.

16. The method of claim 15, wherein the formation of the second conductive oxide layer is performed at room temperature.

17. The method of claim 13, wherein a step of etching the first conductive oxide layer, the conductive layer containing silver (Ag), and the second conductive oxide layer simultaneously is further comprised after the formation of the second conductive oxide layer.

18. The method of claim 17, wherein the etching is performed by wet etching.

19. The method of claim 13, wherein the formation of the second conductive oxide layer comprises exposing the second conductive oxide layer to at least one selected from among oxygen gas (O2), hydrogen gas (H2), and water vapor (H2O).

20. The method of claim 19, wherein the formation of the second conductive oxide layer comprises exposing the second conductive oxide layer to nitrogen-containing gas.
